(19) United States
(12) Patent Application Publication
(10) Pub. No.: US 2002/0120701 A1
(43) Pub. Date: Aug. 29, 2002

(54) Electronic mail system and method for forming electronic mail

(76) Inventor: Akio Ohba, Kanagawa (JP)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/075,875

(22) Filed: Feb. 14, 2002

(30) Foreign Application Priority Data
Feb. 16, 2001 (JP) P2001-40077
Feb. 4, 2002 (JP) P2002-27387

(51) Int. Cl. G06F 15/16

(52) U.S. Cl. 709/206

(57) ABSTRACT

An electronic mail system includes a first storage unit operable to store a plurality of contents data, a second storage unit operable to store a mail template having a screen for forming an electronic mail and a layout of the contents data on the screen, and a controller operable to select a portion of the contents data in response to a user's input, to form an electronic mail file with the portion of the contents data added thereto, and to form an electronic mail for displaying the screen on a display with the portion of the contents data arranged according to the mail template,

### CROSS-REFERENCE TO RELATED APPLICATIONS

The present application claims priority from Japanese Application Nos. 2001-40077 filed Feb. 16, 2001 and 2002-27387 filed Feb. 4, 2002, the disclosures of which are hereby incorporated by reference herein.

### BACKGROUND OF THE INVENTION

The present invention relates to a technique for forming document or electronic mail, especially to a technique for forming document or electronic mail including multimedia information, in other words, contents such as images or voices.

Through widespread communication networks typified by the Internet, various kinds of people can exchange information between each other using electronic mail (e-mail). Using available Internet e-mail techniques, one can send content such as an image or picture (including motion picture) or a voice, in other words, so-called “multimedia information,” along with writing in text format. MIME (Multi-purpose Internet Mail Extensions) is a well-known format in which multimedia information is attached with text information of e-mail. Now, in the foregoing description, the “content” may include text, voice, motion pictures, and still pictures, and data describing them. Furthermore, the “content” may include game data or Java Applets, both of which can be used to control a computer.

However, inputting text data is a time-consuming operation for one who is not familiar with keyboard operations or kana-kanji conversion (front-end processing) operations. Furthermore, in attaching content such as an image or voice, a certain level of skill of forming the content or editing the content material is required for an operator. Trimming images, changing the resolution of images, changing the size of images, dipping sounds, and changing formats for saving data, etc. are examples of editing.

Consequently, it is difficult for the ordinary person to form an e-mail, especially to form and edit content as multimedia information and to form an e-mail having this content attached. Furthermore, in order to utilize an image or sound that already exists, one should pay attention to copyright or right of portrait for this image or sound. And, from a legal point of view, one cannot attach the image or the sound to an e-mail and send this e-mail without permission from the owner of the copyright for this image or sound. For example, attaching a photo image which is acquired from a web site on the Internet to an e-mail and sending this e-mail may be infringement of copyright of this photo image unless the owner of the copyright permits utilization of this photo image.

On the other hand, in traditional mail such as a pictorial postcard or various kinds of greeting cards (Christmas cards, birthday cards, etc.), all of which act as a traditional method of exchanging information, things associated with sending the mail, such as the situation of the sender based on a stamp on the mail, or a picture or selected design of the card, are sometimes more important than the content of the text. In other words, when information is exchanged through the pictorial card or the greeting card, communicating information on the situation of the sender (the sender is traveling, etc.) to the receiver is more important than the content of the text in many cases.

If someone is going to produce the same effect using an e-mail as one gained from the traditional mail described above, attaching content as multimedia information is essential; the receiver can learn about the situation of the sender from the attached content more accurately than from an e-mail including text only. However, for the reason described above, it is difficult to attach content as multimedia information to an e-mail.

Therefore, it is an object of the present invention to provide a system for forming an e-mail easily, especially for attaching contents as multimedia information to the e-mail easily.

### SUMMARY OF THE INVENTION

According to one aspect of the present invention, there is provided an electronic mail system, including a first storage unit operable to store a plurality of contents data; a second storage unit operable to store a mail template having a screen for forming an electronic mail and a layout of the contents data on the screen; and a controller operable to select a portion of the contents data in response to a users input, to form an electronic mail file with the portion of the contents data added thereto, and to form an electronic mail for displaying the screen on a display with the portion of the contents data arranged according to the mail template.

It may be arranged that the mail template further includes a dialog screen relating to the contents data and answer options in the dialog screen, and the controller may display the dialog screen on the display with the answer options arranged therein, form answer data in response to the user's input, and form the electronic mail file with the answer data added thereto.

According to another aspect of the present invention, there is provided an electronic mail system, including a first storage unit operable to store second contents data relating to first contents data; a second storage unit operable to store a mail template having a screen for forming electronic mail and a layout of the second contents data on the screen; and a controller operable to form an electronic mail with a portion of the second contents data added thereto in accordance with the mail template based on a viewing of the first contents data by a user.

According to another aspect of the present invention, there is provided a method for forming electronic mail having contents data added thereto, the method including loading a mail template having a screen for forming electronic mail and layout information of the contents data on the screen, the contents data being a target to be added thereto; displaying the contents data according to the screen and the layout information; allowing a user to select any of the contents data; and forming an electronic mail file with the selected contents data added thereto.

It may be arranged that the mail template further includes a dialog screen relating to the contents data and answer options in the dialog screen, and the method for forming electronic mail may further include displaying the dialog screen with the answer options arranged thereon; allowing the user to select any of the answer options; and forming the electronic mail file with the selected answer options added thereto.

According to another aspect of the present invention, there is provided a method for forming electronic mail having second contents data relating to first contents data added thereto, the method including loading a mail template having a screen for forming an electronic mail and layout information for the second contents data on the screen, the second contents data being a target to be added thereto based on a viewing of the first contents data by a user; and forming an electronic mail file with the second contents data added thereto in accordance with the mail template.

According to another aspect of the present invention, there is provided a computer program for forming an electronic mail with contents data added thereto, the computer program controlling a data processing unit to perform the steps of loading a mail template having a screen for forming an electronic mail and layout information for the contents data in the screen, the contents data being a target to be added thereto; displaying the contents data according to the screen and the layout information; allowing a user to select any of the contents data; and forming an electronic mail file with the selected contents data added thereto.

It may be arranged that the mail template further includes a dialog screen relating to the contents data and answer options in the dialog screen, the computer program controlling the data processing unit to perform the further steps of displaying the dialog screen with the answer options arranged thereon; allowing the user to select any of the answer options; and forming the electronic mail file with the selected answer options added thereto.

According to another aspect of the present invention, there is provided a computer program for forming electronic mail having second contents data relating to first contents data added thereto, the computer program controlling a data processing unit to perform the steps of loading a mail template having a screen for forming an electronic mail and layout information for the second contents data in the screen, the second contents data being a target to be added thereto based on a viewing of the first contents data by a user; and forming an electronic mail file with the second contents data added thereto in accordance with the mail template.

In the electronic mail system, the method for forming electronic mail, and the computer program as described above, it may be arranged that the contents data includes at least one of text data, still picture data, motion picture data, and sound data.

It may be arranged that the computer program as described above is provided in a computer-readable recording medium.

### BRIEF DESCRIPTION OF THE DRAWINGS

The present invention will be understood from the detailed description given hereafter, taken in conjunction with the accompanying drawings.

FIG. 1 is a block diagram showing an overall structure of the electronic mail system according to the preferred embodiment of the present invention.

FIG. 2 is a block diagram of the terminal device according to the preferred embodiment of the present invention.

FIG. 3 is a functional block diagram of the e-mail function in the terminal according to the preferred embodiment of the present invention.

FIG. 4 is a flowchart showing a process of forming e-mails according to the preferred embodiment of the present invention.

FIG. 5 to FIG. 9 are diagrams showing examples of images displayed on a screen in the process of forming e-mails.

### DETAILED DESCRIPTION

Now, a system according to a preferred embodiment of the present invention will be described with reference to the accompanying drawings.

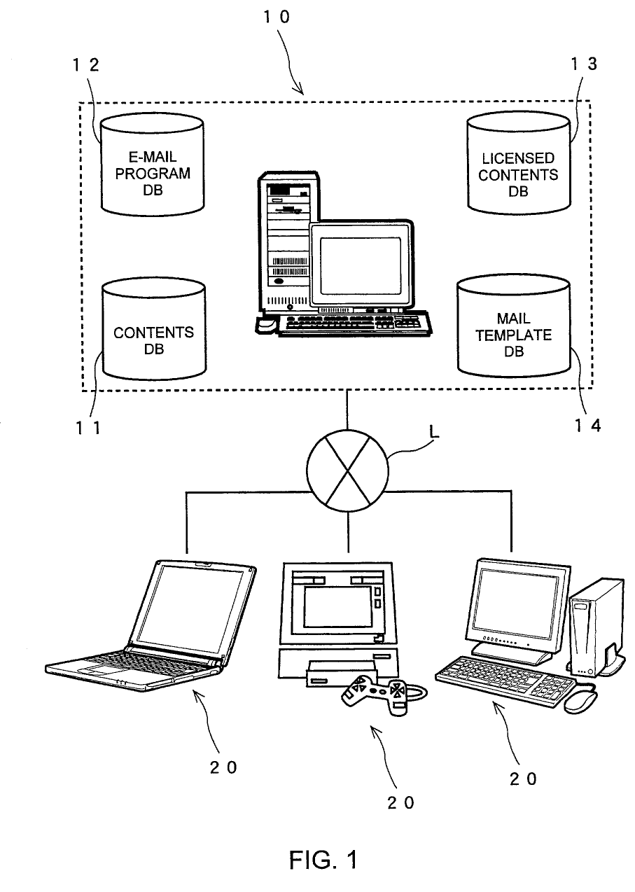

FIG. 1 is a block diagram showing an overall structure of the electronic mail system according to the preferred embodiment of the present invention.

A contents distribution server 10 which distributes contents such as multimedia information, and a terminal device 20 which plays the contents for a user, are connected with each other via a network L, such as the Internet, etc. which an anonymous user can access. In the foregoing description, the network L acts such that a device connected with the network L can transmit information to and receive information from a targeted device when a session is established between them. In FIG. 1, the network L is illustrated in a simplified fashion, but, in fact, the configuration of the network L is usually more complicated than the illustrated configuration. For example, the Internet consists of a plurality of networks combined with each other via gateway servers. The connection to the network is not limited to having a device connected with a backbone network directly; the device can be connected to the network L temporarily, such as a PPP (Point to Point Protocol) connection, etc. to the extent that information can be transmitted to and received from the device when the session is established between the device and a server. In FIG. 1, a part of the network is illustrated as a single line, but, in fact, a plurality of communication lines may be connected with each other.

The contents distribution server 10 is a data processing device and can transmit data to and receive data from the terminal device 20 via the network L. The contents distribution server 10 includes a contents database (in the following description, database is referred to as DB) 11 in which contents are stored as digital data, an e-mail program DB 12 storing a program (e-mail program) to achieve an e-mail function utilizing the stored contents, a licensed contents DB 13 in which contents such as pictures or music permitted or licensed to a user for distribution in the form of e-mail attachments (licensed contents) are stored, and a mail template DB 14 in which mail templates (e-mail templates) corresponding to contents are stored.

In the contents DB 11, contents such as a movie, music, or a video game, all of which are distributed from the contents distribution server 10, are stored as digital data. And, upon request of the terminal device 20 via the network L, the requested contents data are read from this contents DB 11.

In the e-mail program DB 12, the e-mail program for achieving the e-mail function customized in accordance with the contents stored in the contents DB 11 is stored.

In the licensed contents DB 13, contents that are licensed to the user are stored. The licensed contents are, for example, a movie preview video, a publicity poster image, an image of a CD album jacket, or a voice corresponding to a part of music. The licensed contents are prepared for each of the contents stored in the contents DB 11.

In the mail template DB 14, mail templates are stored, each of which corresponds to each of the contents stored in the contents DB 11. Mail templates are, for example, of a text-based form, of a layout-based form, of a supplied contents (phrase, cut)-based form, or of a complete mail-based form. The mail template of a particular form is selected among these mail templates based on a decision of a contents distributor, and is designated by a mail creation rule. This decision includes whether a questionnaire should be included or not.

The mail template forms a certain kind of antecedent of the final e-mail format. That is to say, the mail template is comprised of a mail format and a control code. The mail format is a kind of language or rule that enables both the licensed content to be used and its layout representation to be displayed on different terminal devices equivalently. More specifically, the mail template can be implemented using XML (extensible Markup Language) and JAVA(Trademark). In this case, XML corresponds to the mail format, and JAVA corresponds to the control code. But XML and JAVA are only examples of the mail format and the control code; another widely distributed structured language such as HTML (HyperText Markup Language) can be used as the mail format, and another control code such as ActiveX, which an OS (Operating System) like Windows can interpret, can be used as the control code.

In the case in which the content is a movie, the mail template corresponding to this content is comprised of information designating a location of the licensed contents (moving picture, still picture, sound, etc.) corresponding to this movie, information on the layout of the licensed contents in the e-mail, examples of messages by which someone will become interested in the movie, such as a sales point of the movie or an impression of the movie, and information on the layout of the messages.

Upon request of the terminal device 20, the contents distribution server 10 distributes the requested contents, the e-mail program, the licensed contents and the mail templates corresponding to the requested contents from the databases described above to the requesting terminal device 20.

The terminal device 20 is a data processing device such as a personal computer or a entertainment system that is connected to the network L and can transmit data to and receive data from another terminal device or the contents distribution server 10. The terminal device 20 obtains the contents data from the contents distribution server 10 via the network L and plays back the obtained contents data for the user.

Instead of obtaining the contents, the licensed contents, the e-mail program and the mail templates from the contents distribution server 10, the terminal device 20 may be equipped with a device for playing media, such as a CD (Compact Disc) or DVD (Digital Versatile Disc), and may obtain such data from the media. The contents, the e-mail program and the licensed contents corresponding to these contents, and the mail template customized for these contents may be recorded in the media.

Furthermore, a website from which the e-mail program, the licensed contents or the mail template can be downloaded may be provided apart from the contents distribution server 10 described above. This website can transmit data to and receive data from the contents distribution server 10 or the terminal device 20 via the network L. In such a case, the contents are so constructed that information on the location of these data on the network (for example, a URL (Uniform Resource Locator) or IP (Internet Protocol) address) can be obtained from the contents.

In such website, a password or a key which can be obtained only by the user buying the contents officially may be set up. As a result, only the user officially buying the contents can utilize the website. As described above, various patterns of distributing the e-mail program, the licensed contents and the mail templates exist, and any combination of the patterns of distribution meets the concept of the present invention.

The terminal device 20 has the ability to form and send e-mail utilizing the contents by executing the e-mail program and the mail template obtained from the contents distribution server 10, various kinds of media or websites. Furthermore, the terminal device 20 has the ability to receive e-mail with the contents attached and to play back these contents for the user. Thus, the user of the terminal device 20 can send or receive e-mail utilizing the contents.

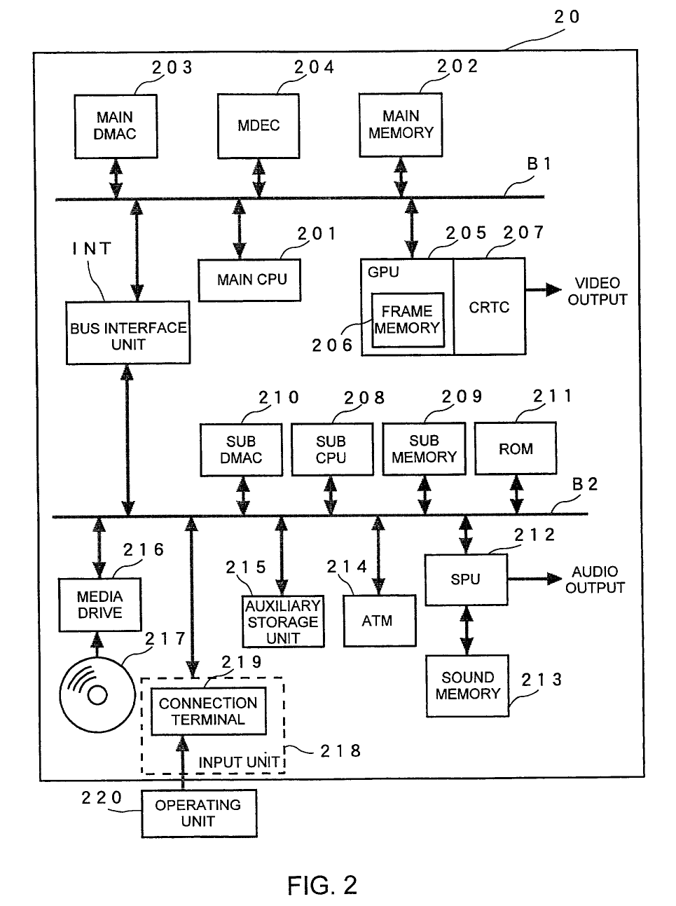

FIG. 2 is a block diagram of an example of a data processing device that can be utilized as the terminal device 20. This terminal device (data processing device) 20 has a function of playing media as well as being connectable to the network L, and is an entertainment device with which the user can play video games in addition to playing back video or sound.

This terminal device 20 is equipped with two bus lines, a main bus line B1 and a sub bus line B2. These bus lines B1 and B2 may be connected with each other and detached from each other via a bus interface unit INT.

A main CPU 201, a main memory 202 comprising a RAM, a main DMAC (Direct Memory Access Controller) 203, an MPEG (Motion Picture Experts Group) decoder (MDEC) 204 and a GPU (Graphic Processing Unit) 205 having a built-in frame memory 206 are connected with the main bus line B1. A CRTC (CRT Controller) 207 that forms video output signals is connected with the GPU 205.

The main CPU 201 loads a boot program from a ROM 211 on the sub bus line B2 via the bus interface unit INT at the startup of the terminal device 20 and executes this boot program to run an operating system of the terminal device 20. The main CPU 201 controls a media drive 216 to load an application program, data etc. from a media 217 mounted on the media drive, and stores this application program, etc. in the main memory 202. Furthermore, the main CPU 201 executes geometry processing on a variety of data read out from the media, for example, data (coordinate values of the vertices (representative points) of a polygon, etc.) of a three-dimensional object comprising a plurality of fundamental figures (polygons). The main CPU 201 forms a display list, the content of which is information on defining polygons through this geometry processing.

The information on defining polygons is comprised of configuration information on the drawing area and polygon information. The configuration information on the drawing area is comprised of values of offset coordinates at an address of the frame buffer of the drawing area and values of coordinates of a drawing dipping area to cancel the drawing when the coordinates of the polygons are located out of the drawing area. The polygon information is comprised of polygon attribute information and vertex information; the polygon attribute information is information specifying shading mode, a-blending mode, texture mapping mode, bump mapping mode, etc., and the vertex information is information on coordinates inside a vertex drawing area, coordinates inside a vertex texture area, a color of the vertex, etc.

The GPU 205 holds a drawing context and reads out a corresponding drawing context based on identification information on an image context which is included in a display list supplied by the main CPU 201. Furthermore, the GPU 205 executes rendering processing using this drawing context and draws a polygon on the frame memory 206. The frame memory 206 can be utilized as a texture memory. Therefore, pixel images on the frame memory 206 can be mapped on a polygon to be drawn as a texture.

The main DMAC 203 controls DMA (Direct Memory Access) data transfer for each circuit connected to the main bus line B1, and controls DMA data transfer for each circuit connected with the sub bus line B2 depending on the status of the bus interface unit INT.

The MDEC 204 operates in parallel with the main CPU 201 and decompresses or decodes the contents data compressed according to the MPEG format or JPEG (Joint Photographic Experts Group) format, etc.

A sub CPU 208 comprising a microprocessor, etc., a sub memory 209 comprising a RAM, a sub DMAC 210, a ROM 211 in which programs such as an operating system are stored, a sound processing unit (SPU) 212 which reads out sound data stored in the sound memory 213 and outputs this data as an audio output, a communication control unit (ATM) 214 which transmits information to and receives information from an external device, such as the contents distribution server 10, via the network L, an auxiliary storage unit 215 comprising a mass storage unit such as a hard disk unit, a media drive 216 for a media 217, such as a CD, DVD, etc. mounted thereon, and an input unit 218 are connected to the sub bus line B2.

The sub CPU 208 executes a variety of operations according to the program recorded in the ROM 211. The sub DMAC 210 controls DMA data transfer, etc. for each circuit connected to the sub bus line B2 only when the main bus line B1 and the sub bus line B2 are detached from each other via the bus interface unit INT.

The ATM 214 receives the contents, the e-mail program, etc. from the contents distribution server 10. The received contents may be played immediately and output as video output or audio output, or may be stored in the auxiliary storage unit 215. The input unit 218 is comprised of a connection terminal 219 to which the input signals from an operating unit (controller) 220 are input. The user executes a variety of input operations using this operating unit 220.

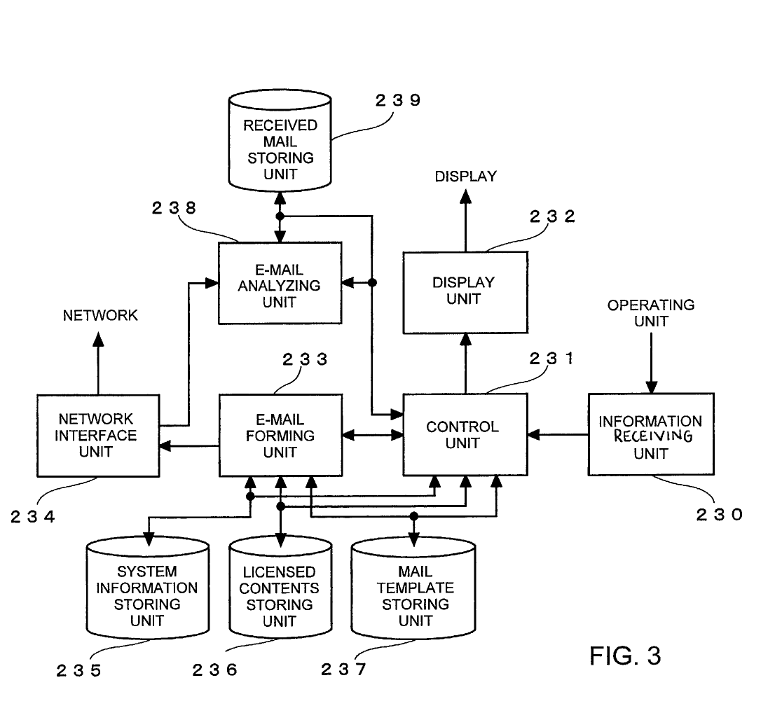

FIG. 3 is a functional block diagram of an e-mail function of the terminal device 20. This function is formed in response to the execution of the e-mail program obtained from the contents distribution server 10 (preferably from the e-mail program DB 12) or the media 217. As shown in FIG. 3, the terminal device 20 is comprised of an information receiving unit 230, a control unit 231, a display unit 232, an e-mail forming unit 233, a network interface unit 234, a system information storing unit 235, a licensed contents storing unit 236, a mail template storing unit 237, an e-mail analyzing unit 238, and a received mail storing unit 239.

The e-mail program may be executed at any time, such as before playing contents, after playing contents, or during the playing of contents.

For example, in order for the user viewing or hearing content to be able to send an e-mail corresponding to this content to another person (acquaintance, friend, etc.) after playing the content, the terminal device 20 displays a question on a display of the terminal device 20 asking whether the user is going to form an e-mail. In this case, it is convenient for the user to display an e-mail forming screen on the display of the terminal device 20 in response to the user's decision to form an e-mail.

Alternatively, the e-mail program may be booted automatically in response to an instruction by the content at a predetermined time, such as before playing the content, after playing the content, or during the playing of the content. Furthermore, the e-mail program may be booted automatically by the operating system (OS) of the terminal device 20 at a predetermined time, such as before playing the content, after playing the content, or during the playing of the content.

In response to the instruction to form the e-mail, the terminal device 20 obtains the e-mail program, the licensed content and the mail template, all of which correspond to the content, from the source of the content (the contents distribution server 10 or the media 217) or from the websites which provide the e-mail program, the licensed content and the mail template described above.

The information receiving unit 230 receives a variety of information input by the operating unit 220. This information is necessary for forming the e-mail. The received information is sent to the control unit 231.

The control unit 231 controls a variety of operations based on information sent by the information receiving unit 230. For example, the control unit 231 controls the display unit 232 to show a predetermined image on the display, and sends the information necessary for forming the e-mail to the e-mail forming unit 233.

The displaying unit 232 shows images on the display of the terminal device 20 in response to instructions from the control unit 231.

The e-mail forming unit 233 reads out the mail template from the mail template storing unit 237 in response to an instruction from the control unit 231, reads out the text, image, and sound, etc. from the licensed contents storing unit 236, and forms a dialog screen for forming an e-mail based on these read-out data. The e-mail forming unit 233 incorporates in the dialog screen the necessary system information (present time, etc.) from the system information storing unit 235.

The network interface unit 234 sends the e-mail formed by the e-mail forming unit 233 to the designated e-mail address via the network L. The network interface unit 234 receives a variety of data described above from the content distribution server 10, websites, etc. and distributes these data to the e-mail forming unit 233.

In the system information storing unit 235, the system information of the terminal device 20, a history of viewed contents, and personal information (name, age, sexuality, address, etc.) of the user are stored. In the licensed contents storing unit 236, the licensed contents obtained from the source of the contents are stored. In the mail template storing unit 237, the mail template obtained from the source of the contents are stored.

The email analyzing unit 238 analyzes e-mail received from another terminal device 20 via the network interface unit 234. The received e-mail is stored in the received mail storing unit 239.

First Application

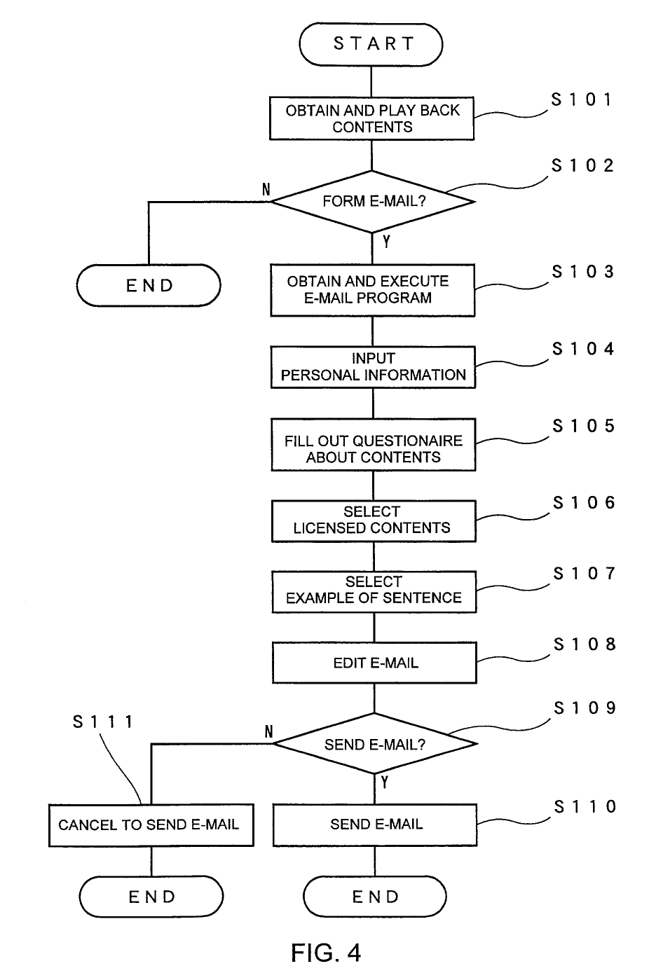

Using the contents distribution server 10 and the terminal device 20 described above, the user of the terminal device 20 can send and receive e-mail according to the procedure shown in the flowchart of FIG. 4. In this embodiment, an example is described in which the user views a movie as the content.

In step S101, the terminal device 20 obtains contents data of the movie from the contents distribution server 10 or the medium 217 and plays back the contents data. The user can view the movie using the terminal device 20. In step S102, the terminal device 20 displays a question on the display of the terminal device 20 at or after the end of the movie asking whether the user wishes to form an e-mail utilizing the image or sound of this movie. If the determination of step S1 02 is NO, in other words, the user does not wish to form an e-mail, the procedure ceases.

On the other hand, if the determination of step S102 is YES, in other words, the user wishes to form an e-mail, the terminal device 20 loads the e-mail program from the contents distribution server 10 or the medium 217 and executes the e-mail program in step S1 03. Through this execution of the e-mail program, the functional blocks shown in FIG. 3 are formed in the terminal device 20.

It is preferable that an official home page of the movie be set up in a website in the network L, and the e-mail program may be obtained from this website as well as from the contents distribution server 10 and the media 217. In the case that the e-mail program is obtained from the official home page, it is more preferable that a web address of the official home page, in other words, location information of the official home page in the network L such as a URL or IP address, be obtained along with the contents data of the movie. And it is more preferable that the terminal device 20 may automatically access the official home page and download the e-mail program in response to the user's command to form an e-mail. The licensed contents (cut of the promotion film, background music (BGM), and phrase of high point of soundtrack, etc.) corresponding to the movie and the mail template may also be disposed in the official home page, and in the case that these contents, etc. are disposed in the official home page, it is more preferable that the terminal device 20 may download these contents.

The e-mail program loads a mail template corresponding to the movie (content) from the mail template storing unit 237 and executes the following process in accordance with the details of this mail template.

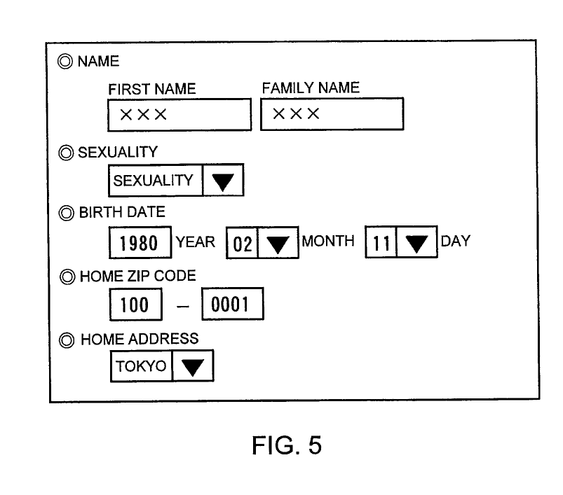

Next, the control unit 231 controls the displaying unit 233 to display the screen shown in FIG. 5 on the display of the terminal device 20. In step S104, the user fills in each item on the screen using the operation unit 220 so as to input personal information of the user. In the example shown in FIG. 5, the name, sexuality, date of birth, zip code and address of the user are to be input as personal information. If these kinds of information are stored in the system information recording unit 235 in advance, the control unit 231 preferably loads and displays this information, and seeks confirmation from the user that these data can be utilized.

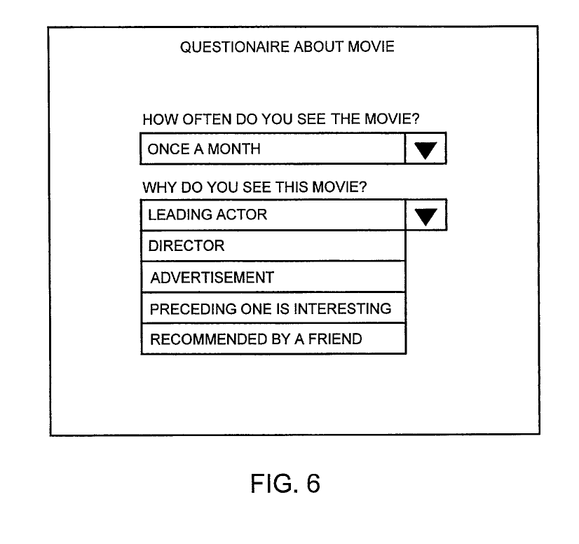

After the user inputs the personal information, a screen as shown in FIG. 6 is displayed on the display of the terminal device 20. In step S105, the user fills out a questionnaire about the movie just played back by selecting from choices prepared for each item by means of the operation unit 220. In the example shown in FIG. 6, the user fills out the questionnaire by selecting from the choices on the screen by means of the operation unit 220; thus, the user need not execute complicated operations to input the information. These items and the choices are provided as information by the distributor of the movie and embedded in the mail template, or are provided as one of the licensed contents.

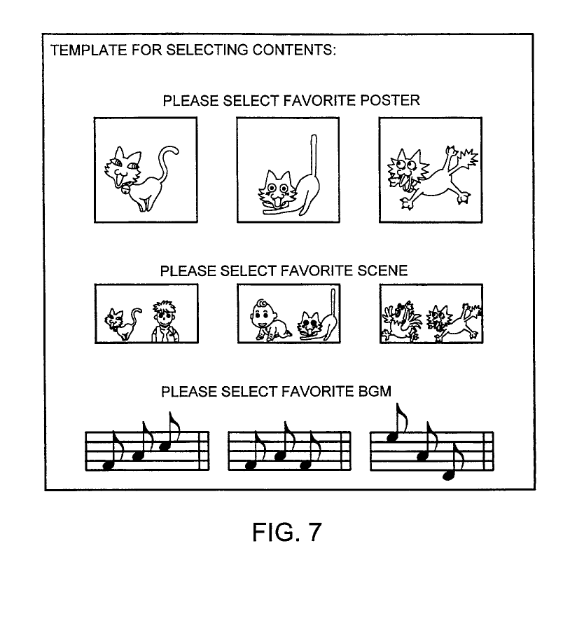

Next, a screen as shown in FIG. 7 is displayed on the display of the terminal device 20. In step S106, the user selects a licensed content corresponding to the movie just played back from the licensed contents displayed on the screen; thus, the licensed content utilized for or to be attached to the e-mail is selected.

Described in more detail, the control unit 231 controls the displaying unit 232 to show a list of icons on the display of the terminal device 20, each of which corresponds to a licensed image or sound stored in the licensed contents storing unit 236. The user selects one icon corresponding to the user's favorite licensed content from these icons; thus, the licensed content utilized for or to be attached to the e-mail is selected.

In the example shown in FIG. 7, three kinds of poster images, three kinds of scenes (motion picture) of the movie, and three kinds of BGM (music) are provided for the licensed contents, and the user may select one content for each category (poster image, scene, BGM). The control unit 231 controls the displaying unit 232 to show the icons on the display of the terminal device 20, each of which corresponds to one of the poster images, one of the scenes of the movie, and one of the kinds of BGM. The user selects one icon of a poster image, one icon of a scene of the movie, and one icon of a BGM by means of the operation unit 220.

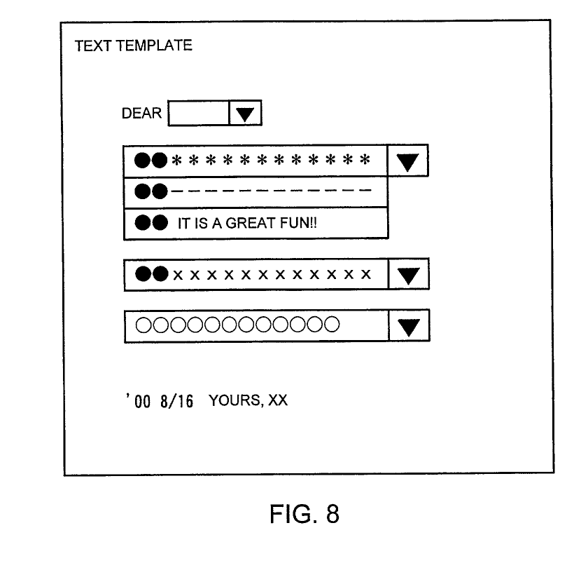

Next, a screen as shown in FIG. 8 is displayed on the display of the terminal device 20. In step S107, the user selects a sentence to be used in the e-mail from a plurality of sentences displayed on the screen; thus, the sentence to be used in the e-mail is selected.

Described in more detail, the control unit 231 controls the displaying unit 232 to show a list of example sentences on the display of the terminal device 20. In the example shown in FIG. 8, a plurality of sentences which praise the movie, or a plurality of sentences which lead the receiver of the e-mail to be tempted to see the movie, are prepared in the mail template as example sentences prepared by the distributor of the movie, and the user selects a sentence from among these sentences. Displaying a plurality of example sentences in the style of pull-down menus for enabling the user to choose one example sentence, as shown in FIG. 8, is one example of a method for choosing a sentence, but it is understood that the method for choosing a sentence is not limited to the illustrated example. Another well-known method for choosing a sentence can be applied. In the example shown in FIG. 8, the user inputs the text of the e-mail by selecting from example sentences on the screen by means of the operation unit 220; thus, the user need not execute complicated operations to input the information.

In this case, an address of the e-mail may be input by means of the operation unit 220, or may be selected from a list of addresses already stored in the system information storing unit 235. The method of selecting an address from the list of e-mail addresses is well known in the art, so a detailed explanation of this method will not be provided herein. But one example of this method is to display the list of addresses in the style of pull-down menus so that the user may select one address, as shown in FIG. 8.

In step S108, the e-mail forming unit 233 edits the input and the selections described above and forms the e-mail. The control unit 231 sends information indicating the selected licensed content and information indicating the selected example sentence to the e-mail forming unit 233. The e-mail forming unit 233 loads the corresponding licensed content and the sentence from the licensed contents storing unit 236 and the e-mail template storing unit 237 based on this information and inserts them into their predetermined positions in the mail format of the selected mail template. Moreover, the e-mail forming unit 233 loads information on the present time and date from the system information recording unit 235 and inserts this information into its predetermined position in the mail format. The e-mail is formed in this manner.

The mail template defines the procedure of forming the e-mail and the control procedure of displaying the screens as described above. For this reason, the mail template is prepared for each content.

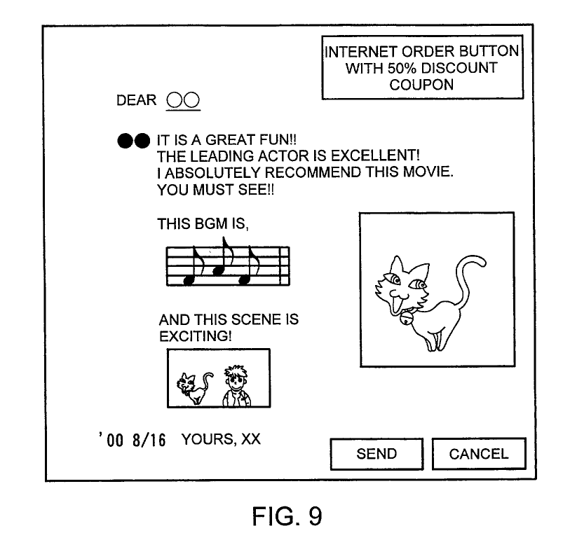

The finished e-mail is sent from the e-mail forming unit 233 to the control unit 231, and the displaying unit 232 displays the finished e-mail on a screen of the display of the terminal device 20. The finished e-mail is, for example, as shown in FIG. 9. The user checks the finished e-mail, and if the user decides to send this e-mail, he or she selects the “send” button on the screen, as shown in FIG. 9. When the “send” button is selected, in other words, the determination of step S109 is YES, the e-mail forming unit 233 sends the e-mail via the network interface unit 234 in step S110.

It is preferred that the terminal device 20 be able to send the answer data for the questionnaire input by the user during the process of forming the e-mail to the contents distribution server 10 or another server (the server of the movie distributor). In this way, the movie distributor can collect the user's impression of the movie, etc. automatically.

On the other hand, if the user decides not to send the e-mail, he or she selects the “cancel” button on the screen, as shown in FIG. 9. When the “cancel” button is selected, in other words, the determination of step S109 is NO, the e-mail forming program ceases the procedure in step 111 without sending the e-mail.

The instruction of sending the e-mail or canceling the e-mail described above may be given by the users operation of a button in the terminal device 20 or the operation unit 220.

Meanwhile, the button displayed on the upper right of the screen shown in FIG. 9 is an order button with a discount credit. A user receiving the e-mail is capable of buying the movie content discounted by 50%. More particularly, an order processing program invoked in response to selection of this button is embedded in the e-mail. When the user selects the button after receiving the e-mail, the above-mentioned order processing program runs on the terminal device 20 and accesses a contents selling server on the network. As a result, ordering of movie contents, etc. and payment can be achieved. Alternatively, the order button with the discount credit links to the URL of the above-mentioned contents selling server, and the terminal device 20 may accesses this URL in response to the selection of the button by the user.

As described above, according to the preferred embodiment, the user can form an e-mail comprising text, images and sound by making selections through the use of the operation unit 220 while minimizing complicated input operations as much as possible. The user can easily form the e-mail with multimedia information attached without special knowledge or experience about multimedia technology. Furthermore, the user can share the users impression of the movie (information on the situation of the user at the time) with another person by an e-mail utilizing a picture or BGM of the movie.

Second Application

The present invention may be applied to a case in which a video game is utilized as content.

In the video game, especially in an RPG (Role Playing Game), a variety of events are carried out in accordance with the start of the game. The events are, for example, the input of a character at the start of the game, shopping in a town in the game space, an exploration, etc. In this case, a mail template that forms e-mail corresponding to the progress of the game is preferable.

In the progress of the video game, information about the game (situation information), such as the history of the game varying according to the progress of the game or a score of the game at the time, is recorded in the system information storing unit 235. In response to an instruction from the user to form an e-mail, the control unit 231 loads the mail template available at the moment from the mail template storing unit 237 with reference to the situation information in the system information storing unit 235, and controls the display unit 232 to display an e-mail forming screen on the display of the terminal device 20 based on the situation information at the moment. As in the first embodiment, the user selects his or her favorite licensed content or example sentence from the licensed contents or example sentences defined in the mail template. The e-mail is formed using the selected licensed contents and example sentence. For example, licensed contents and the example sentences are provided which are suitable for a situation or stage in accordance with the progress of the game. The stage is, for example, as described below:

(1) Start of the Game

A history of purchase, an opening cut, the name of a selected character, the image of the character, configuration information about an organized team, and licensed contents such as pictures are provided in the mail template to notify the user's friend that the game has been purchased.

(2) During the Progress of the Game (Part 1)

A history of the game, a situation of the game (a situation of the team, etc.), information about a checkpoint character, licensed content such as a cut of a checkpoint event, a picture (pictorial postcard) of an unexplored territory event, or a hint for playing the game are provided in the mail template to notify another person of the stage of progress of the game.

(3) During the Progress of the Game (Part 2)

The score of the game, licensed contents such as tool data for the game, or item data are provided in the mail template for exchanging game information or giving the present values in the game to the user's friend playing the same game.

(4) During the Progress of the Game (Part 3)

An order list of real products, an order confirmation, an acknowledgment, an address for delivering the products, licensed content such as a letter attached to the product to be delivered are provided in the mail template for the game distributor or an affiliate company in order to handle to the order of products related to the game.

(5) After the Finish of the Game

The history of the game, licensed contents such as a memory event, hints for playing the game, or the impression of the game are provided in the mail template for sharing the user's impression of the game with the user's friend.

As described above, the user can share the user's experiences with another person in the same manner as a pictorial postcard by using an e-mail at every stage. Furthermore, these e-mails can be advertisements for the game.

Moreover, as described above, the user can send an e-mail to the distributor of the game or to another player with the real-time experiences of the user attached.

For example, the user who asks for hints for playing the game in order to proceed to the next stage can send an inquiry e-mail to the distributor of the game as he or she plays the game. The distributor of the game who receives the inquiry e-mail can refer to the real-time experiences of the user attached to the e-mail, so that the distributor of the game can give the user an appropriate hint (a hint which does not disturb the progress and direction of the game while meeting the user's request) while preventing careless exposure of information.

Furthermore, the user can make a successful communication with another player about the game via an e-mail. In the second embodiment described above, an example applied to an RPG is explained in detail. However, the second embodiment can be applied not only to an RPG, but also to a variety of game such as an action game or simulation game. Preferably, the second embodiment may be applied to a game in which the history of the game formed in accordance with the progress of the game has some kind of meaning or value for the user.

Third Application

The present invention may be applied to a case in which a map or sightseeing database is used as content.

In a car navigation system or in a configuration where a mobile information terminal such as a mobile phone is equipped with a small peripheral memory unit, location information acquired by the car navigation system or the mobile information terminal can be stored or recorded in a memory unit in the car navigation system or the peripheral memory unit. Such location information acquired by the mobile information terminal, etc. is important data indicating the movement of the user. Consequently, it is preferable for the terminal device 20 to control the peripheral memory unit, the car navigation system or the mobile information terminal to transfer such location information as described above to the terminal device 20, and to identify the path of the user's movement on a map or sightseeing database. Thus, it is possible to form an e-mail in which plenty of data of visited places are incorporated by searching sightseeing data in the map or sightseeing database based on the path of the user's movement. The map or sightseeing database means a database that provides a map image to be displayed indicating an area in response to the destination name, station name, landmark name, or longitude or latitude information, and that provides information relating to the sightseeing spots located in the area.

For example, when the user visits Kamakura (location name), a mail template is provided that searches or selects the map content in which the travel route of the user is displayed, along with the photo content and caption content of the famous places or historical spots which the user stopped by on the way using the map or sightseeing database based on the location information, and that forms an e-mail having the selected map content, etc. attached. Therefore, the user can easily form an e-mail providing notice of the user's travel, to which the route map and the photos in various places are attached.

While the present invention has been described in terms of the preferred embodiments and the modifications thereof, the invention is not to be limited thereto, but can be embodied in various ways without departing from the principle of the invention as defined in the appended claims. For example, it is not necessary that each server in the preferred embodiment described above be comprised of a single data processing unit; each server may be comprised of a plurality of data processing units which cooperate with each other and execute a predetermined data processing method.

As described above, according to the present invention, the user can form an e-mail which is comprised of text selected from example sentences and the pictures or the sounds of licensed content using an e-mail program corresponding to the content as multimedia information, as well as playing the content, and can send this e-mail to another user. Consequently, the user can form an e-mail with high quality data attached which reflects the real-time situation at the time of utilizing the content by a simple selecting operation, without using a complex editing system. Therefore, it is easy to transmit the user's intention or situation data.

Moreover, the distributor of the contents can obtain so-called word-of-mouth advertisement and can control the detail and the format of the contents to be distributed at the distributor's side. Therefore, the present invention supplies an incentive to the distributor of the contents to provide high-quality contents data and to license the contents easily.

1. An electronic mail system, comprising:
a first storage unit operable to store a plurality of contents data;
a second storage unit operable to store a mail template having a screen for forming an electronic mail and a layout of said contents data on said screen; and
a controller operable to select a portion of said contents data in response to a users input, to form an electronic mail file with said portion of said contents data added thereto, and to form an electronic mail for displaying said screen on a display with said portion of said contents data arranged according to said mail template,

2. An electronic mail system according to claim 1, wherein
said mail template further includes a dialog screen relating to said contents data and answer options in said dialog screen; and
said controller is operable to display said dialog screen on said display with said answer options arranged therein, to form answer data in response to said users inputs, and to form said electronic mail file with said answer data added thereto.

3. An electronic mail system according to claim 1, wherein said contents data is at least one of text data, still picture data, motion picture data, and sound data.

4. A method for forming electronic mail having contents data added thereto, comprising:
loading a mail template having a screen for forming an electronic mail and layout information for the contents data on the screen, the contents data being a target to be added thereto;
displaying the contents data according to the screen and the layout information;
allowing a user to select any of the contents data; and
forming an electronic mail file with the selected contents data added thereto.

5. A method for forming electronic mail according to claim 4, wherein the mail template further includes a dialog screen relating to the contents data and answer options in the dialog screen, the method further comprising:
displaying the dialog screen with the answer options arranged therein;
allowing the user to select any of the answer options; and
forming the electronic mail file with the selected answer options added thereto.

6. A method for forming electronic mail according to claim 4, wherein the contents data is at least one of text data, still picture data, motion picture data, and sound data.

7. A computer program for forming electronic mail having contents data added thereto, the computer program controlling a data processing unit to perform the steps of:
loading a mail template having a screen for forming an electronic mail and layout information for the contents data in the screen, the contents data being a target to be added thereto;
displaying the contents data according to the screen and the layout information;
allowing a user to select any of the contents data; and
forming an electronic mail file with the selected contents data added thereto.

8. A computer program according to claim 7, wherein the mail template further includes a dialog screen relating to the contents data and answer options in the dialog screen, the computer program controlling the data processing unit to perform the further steps of:
displaying the dialog screen with the answer options arranged thereon;
allowing the user to select any of the answer options; and
forming the electronic mail file with the selected answer options added thereto.

9. A computer program according to claim 7, wherein the contents data is at least one of text data, still picture data, motion picture data, and sound data.

10. A computer-readable recording medium in which a computer program according to claim 7 is recorded.

11. A computer-readable recording medium in which a computer program according to claim 8 is recorded.

12. A computer-readable recording medium in which a computer program according to claim 9 is recorded.

13. An electronic mail system, comprising:
a first storage unit operable to store second contents data relating to first contents data;
a second storage unit operable to store a mail template having a screen for forming an electronic mail and a layout of said second contents data on the screen; and
a controller operable to form an electronic mail with a portion of said second contents data added thereto in accordance with said mail template based on a viewing of said first contents data by a user.

14. An electronic mail system according to claim 13, wherein said second contents data is at least one of text data, still picture data, motion picture data, and sound data.

15. A method for forming electronic mail having second contents data relating to first contents data added thereto, comprising:
loading a mail template having a screen for forming an electronic mail and layout information for the second contents data on the screen, the second contents data being a target to be added thereto based on a viewing of the first contents data by a user; and
forming an electronic mail file with the second contents data added thereto in accordance with the mail template.

16. A method for forming electronic mail according to claim 15, wherein the second contents data is at least one of text data, still picture data, motion picture data, and sound data.

17. A computer program for forming electronic mail having second contents data relating to first contents data added thereto, the computer program controlling a data processing unit to perform the steps of:
loading a mail template having a screen for forming an electronic mail and layout information for the second contents data in the screen, the second contents data being a target to be added thereto based on a viewing of the first contents data by a user; and
forming an electronic mail file with the second contents data added thereto in accordance with the mail template.

18. A computer program according to claim 15, wherein the second contents data is at least one of text data, still picture data, motion picture data, and sound data.

19. A computer-readable recording medium in which a computer program according to claim 17 is recorded.

20. A computer-readable recording medium in which a computer program according to claim 18 is recorded.
